(19) United States
(12) Patent Application Publication
(10) Pub. No.: US 2015/0259950 A1
(43) Pub. Date: Sep. 17, 2015

(54) SYSTEM COMPRISING A DOOR ACTUATION PART AND LOCKING CYCLINDER

(71) Applicant: DORMA DEUTSCHLAND GMBH, Ennepetal (DE)

(72) Inventors: Falko Schweitzer, Schwelm (DE); Leo Lorenz, Wartenberg (DE)

(21) Appl. No.: 14/428,716

(22) PCT Filed: Oct. 17, 2013
(86) PCT No.: PCT/EP2013/071753

§ 371 Date: Mar. 17, 2015

(30) Foreign Application Priority Data
Oct. 17, 2012 (DE) 10 2012 020 450.7
Oct. 17, 2012 (DE) 10 2012 020 451.5

(51) Int. Cl. E05B 63/00; E05B 53/00; E05B 27/00

(52) U.S. Cl. CPC E05B 63/006; E05B 27/0003; E05B 53/00; E05B 63/00

(57) ABSTRACT

A system including at least one door actuating member, a locking cylinder, and a connecting element connecting the door actuating member and the locking cylinder, which element is configured in one or more pieces and connects the door actuating member and the locking cylinder via a variable distance to each other, wherein the distance between the door actuating member and the locking cylinder can be adjusted via the connecting element.

### TECHNICAL FIELD

The invention relates to a system comprising a door actuating member, a locking cylinder, and a connecting element connecting the door actuating member and the locking cylinder, which element is configured in one or more pieces and connects the door actuating member and the locking cylinder via a variable distance to each other, wherein the distance between the door actuating member and the locking cylinder can be adjusted via the connecting element. Moreover, the invention relates to a method for connecting a door actuating member to a locking cylinder, in particular while utilizing the inventive system.

### BACKGROUND

Systems, comprising door actuating members and locking cylinders are well known. Door actuating members according to the idea of the application are understood to be for example door handles, door knobs or electronical/electromechanical rotating knobs, by means of which, when manually actuated, a door can be unlocked or opened. In particular electronical/electromechanical rotating knobs are utilized to unlock a lock from a door side exclusively after previous authentication, for example by means of a chip or an admission card. Without such authentication the electronical/electromechanical rotating knob, i. e. according to the idea of the application the door actuating member, is uncoupled from the associated locking cylinder. Therefore, rotating the rotating knob does not result in a rotation of the locking cylinder, in particular not in a following rotation of the closing cam, which rotates along inside the lock. As, in the uncoupled case, the closing cam does not rotate with the rotating knob, the lock is not being unlocked and thus the door cannot be opened. The known door actuating members including the associated locking cylinders are disadvantageous in that they have to be made available in the most various executions adapted to the lock and to the door leaf. In other words, many types of locking cylinders together with as many corresponding door actuating members, which are specifically adapted to the locking cylinders and the particularities of the lock and of the door leaf, need to be kept in stock. Moreover, each type of locking cylinder has consequently its own coupling mechanism, which results in an enormous variety of variants and increases manufacturing costs.

### BRIEF SUMMARY

The inventive system, which comprises a door actuating member, a locking cylinder and a connecting element connecting the door actuating member and the locking cylinder, which element is configured in one or more pieces and connects the door actuating member and the locking cylinder via a variable distance to each other, wherein the distance between the door actuating member and the locking cylinder can be adjusted via the connecting element, offers the advantage that, independently of the construction type, i.e. in particular of the length of the locking cylinder, any door actuating member is adaptable to the locking cylinder via the connecting element. Furthermore, the configuration of the adaptability of the distance between the door actuating member and the locking cylinder via the connecting element offers the advantage of being able to use for example structurally identical locking cylinders having the same length in door leaves having different thickness, the different thicknesses of the door leaves being adaptable via the connecting element, which connects the locking cylinder and the door actuating member to each other via a variable distance. Therefore, the previously large number of locking cylinders, which are adapted corresponding to the type of construction of a door or of a lock and the door actuating members to be connected to the locking cylinders, can be reduced to a minimum. The variability provided by means of the connecting element can thus be reduced from the plurality of forms of locking cylinders of more than 10,000 to just under 100 locking cylinders, to satisfy the requirements of the market.

Advantageously, the door actuating member and the locking cylinder are non-positively and/or positively connected to each other via the connecting element. It is thus guaranteed that upon actuation of the door actuating member, namely that the torque applied to the door actuating member is transferred via the connecting element onto the locking cylinder, for moving the closing cam of the locking cylinder, which cam moves along inside the lock during the locking operation.

In a particularly advantageous manner, the connecting element is suitable to adapt the door actuating member to the position of the locking cylinder. Usually, the locking cylinder is aligned in a lock. Said alignment, which is necessarily caused by the different types of construction and manufacturing tolerances of the locks, partially results in the locking cylinders having an angular offset with regard to the actuating axis, which extends through the door actuating member, in particular the part of the door actuating member being in operative connection with the locking cylinder. In the most extreme case, the alignment of the locking cylinder in the lock may result in the door actuating member not being connectable to the locking cylinder, respectively the transmission of torque from the door actuating member onto the locking cylinder, due to the angular offset, having to be realized at a greater expenditure of force. According to the invention, this circumstance may be avoided with the connecting element which compensates the angular offset between the locking cylinder and the door actuating member.

It is particularly preferred, if the demountability of the system is impeded up to a certain degree by means of the non-positive and/or positive connection between the door actuating member and the locking cylinder provided by means of the connecting element. In this case, the connecting element acts additionally as a safety device, which impedes dismounting of the door actuating member, respectively of the locking cylinder which are connected to each other via the connecting element.

For accommodating the connecting element and for securing the latter, the door actuating member and/or the locking cylinder present(s) at least one reception, which accommodates the connecting element. For preventing a release of the connecting element from the reception of the locking cylinder or of the door actuating member up to a certain degree, and for guaranteeing a non-positive and/or positive connection between the door actuating member and the connecting element, respectively between the locking cylinder and the connecting element, the non-positive and/or positive connection is preferably guaranteed by means of latching the connecting element in the reception of the door actuating member and/or of the locking cylinder.

In addition to latching the connecting element in the reception of the door actuating member and/or of the locking cylinder, the connecting element is preferably adjusted respectively fixed by means of a securing element, which is disposed in the area of the reception. Preferably, the securing element is a spring-loaded pin, which, upon latching of the connecting element in the reception of the door actuating member and/or of the locking cylinder, engages in recesses, such as holes, grooves or other depressions, which are configured in the connecting element. A securing element, which as described above is spring-loaded, is particularly preferred and suitable for securing a connecting element accommodated in the locking cylinder, respectively in the reception thereof, because, on account of the spring load, the securing element automatically engages in the recesses, which are configured in the connecting element. Obviously, the securing element may be likewise a pin or a screw, which, after accommodating the connecting element, are pushed or screwed into the reception, for example of the door actuating member, for engaging in the recesses which are configured in the connecting element.

For latching the connecting element in the reception of the locking cylinder and/or of the door actuating member, it is particularly suitable, if the connecting element is configured, at least at an end side at one side, as a latching shaft. When seen in cross-section, the latching shaft has shaft ridges and shaft troughs, wherein the shaft troughs are configured as depressions, which are configured to be circumferential about the connecting element. The securing element preferably engages in said depressions such that a displacement of the connecting element is prevented by the adjoining shaft ridges of the latching shaft in both the one and the other direction. In this case, the securing element is preferably a shaft lock-down device which is spring-loaded.

For establishing not only a connection between the door actuating member and the locking cylinder, but also for the function of the door actuating member, namely for transferring the torque applied by means of the actuation onto the locking cylinder, the connecting element comprises at least one coupling element, which is configured in one or more pieces. Following the mode of operation of the connecting element, according to the invention, the coupling element as well is configured in such a manner that it allows for transferring the torque from the door actuating member onto the locking cylinder in a variable distance. Said distance just like the connecting element, is also adjustable. Preferably in this case, the coupling element passes through the freely rotatable, respectively stationary parts of the connecting element, such as the latching shaft and is non-positively and/or positively connected to the closing cam.

In a usual manner, the locking cylinder is aligned towards the lock. An angular offset may be created thereby, which results in an alignment error. For compensating said alignment error, a compensating element, for example in the shape of a clip, is inserted into the rosette. In this case, the clip is preferably adapted to the contour of a keyhole in the rosette. The clip does not only serve for being able to compensate an alignment error, but also serves for stabilizing the system, preferably as a bearing for the connecting element. For accommodating the connecting element in the bearing, which, based on its positioning in the rosette, is referred to as a rosette bearing, the connecting element, preferably at its end facing the door actuating member, includes a bearing surface by means of which the connecting element is supported in the rosette bearing. The end of the connecting element facing away from the door actuating member, i. e. the end of the connecting element, which is pushed into the reception of the locking cylinder, preferably likewise has a bearing surface, which serves for supporting the connecting element in the reception of the locking cylinder. In this respect, the connecting element is preferably supported at two locations of the system at bearing surfaces configured at its ends, namely on the one hand in the rosette bearing and, on the other hand, in the bearing which is configured by means of the reception of the locking cylinder. In this case, the clip is preferably configured as a metal or plastic material clip. Obviously, likewise several clips may serve for compensating an alignment error, respectively for serving as a rosette bearing.

With the intention to avoid repeating the advantages of the inventive method, it is referred to the advantageous embodiment of the inventive system and it is fully and comprehensively referred to the latter.

### BRIEF DESCRIPTION OF THE DRAWINGS

Hereinafter, further measures enhancing the invention will be illustrated in the following in conjunction with the description of one preferred embodiment of the invention based on the Figure, in which:

FIG. 1 shows an exploded drawing of an inventive system, which comprises two door actuating members, a locking cylinder and the connecting elements connecting the door actuating members to the locking cylinder.

### DETAILED DESCRIPTION

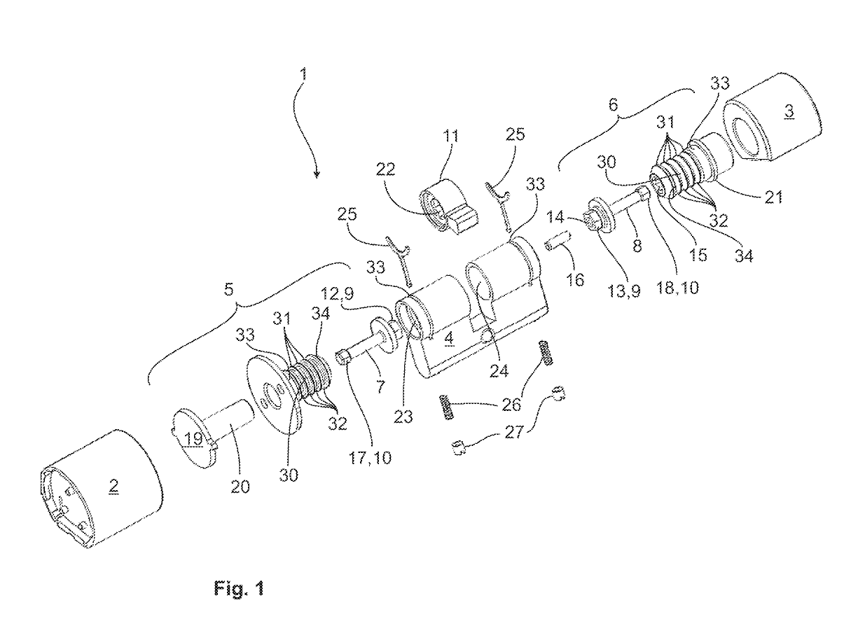

FIG. 1 shows an exploded view of an exemplary embodiment of an inventive system, comprising two door actuating members 2 and 3, a locking cylinder 4, and the connecting elements 5 and 6, which in the present case are configured in several pieces, connecting the door actuating members 2 and 3 and the locking cylinder 4, which connecting elements connect the door actuating members 2 and 3 and the locking cylinder 4 via a variable distance to each other, wherein the distance between the door actuating members 2 and 3 and the locking cylinder 4 is adjustable via the connecting elements 5 and 6.

The connecting elements 5 and 6 comprise latching shafts 30 through which, with regard to the connecting element 5, a coupling element 7 passes and transfers the torque from the door actuating members 2 onto the locking cylinder 4, respectively with regard to the connecting element 6, a coupling element 8 transfers the torque from the door actuating members 3 onto the locking cylinder 4, and engages in the coupling element. In this case, the coupling elements 7 and 8 are preferably configured as a shaft.

For being able to accommodate the latching shafts 30 of the connecting elements 5 and 6, the locking cylinder 4 includes receptions 23 and 24 which, in a usual manner, serve for receiving a cylinder core. For supporting the latching shafts 30 in the receptions 23 and 24, the latching shafts 30, at their ends facing away from the door actuating members 2 and 3, have respectively one bearing surface 34. In this case, the bearing surface 34 has a slightly larger diameter than the diameter of the rings 31 respectively of the shaft ridges of the latching shaft 30. Thereby not only a support of the latching shaft 30 in the locking cylinder 4 is guaranteed, but also the slightly larger diameter of the bearing surface with regard to the rings 31 of the latching shaft 30 also increases the movability of the latching shaft 30 in the reception 23 or 24 outside its axial extension. In other words, the degrees of freedom of an alignment to a locking cylinder 4 aligned in a lock by means of the above described embodiment of the latching shaft 30 are even increased. At the ends facing the door actuating members 2 and 3 respectively one bearing surface 33 is likewise configured at the latching shafts 30, which have a slightly larger diameter than the diameter of the rings 31, respectively of the shaft ridges of the latching shaft 30. Preferably, the bearing surfaces 33 are supported in compensating elements in the shape of a clip, respectively of a rosette bearing, which in the present case, are not illustrated. In this regard, the latching shafts are supported at two locations, namely via the bearing surfaces 33 and 34, namely on the one hand, in the receptions 23 and 24 of the locking cylinder 4, and on the other hand, in the rosette bearings, which in the present case are not illustrated, in the area of the door actuating members 2 and 3.

At their ends 12 and 13 facing away from the respective door actuating members 2 and 3, the coupling elements 7 and 8 have an exterior contour in the shape of a hexagon nut 9, wherein the hexagon nut 9 reaches a torque-proof engagement with a closing cam 11 of the locking cylinder 4.

For this purpose, the closing cam 11 includes in this case an exemplary continuous borehole 22 in the shape of a hexagon bore, by means of which it reaches engagement with the ends 12 and 13 of the coupling elements 7 and 8. In this case, the coupling element 7 itself may be embodied as a hexagon, which reaches a torque-proof engagement with the borehole 22 of the closing cam 11.

In the present case, the coupling elements 7 and 8, at their ends 12 and 13 facing away from the door actuating members 2 and 3, additionally include one respective borehole 14, into which, respectively after having brought the ends 12 and 13 into engagement with the closing cam 11, a draw bolt 16 is inserted, which has the purpose to connect the ends 12 and 13, in particular to clamp the ends 12 and 13.

At the respective ends 17 and 18 facing the door actuating members 2 and 3, the coupling elements 7 and 8 likewise have an exterior contour in the shape of a hexagon nut 10, which reaches a torque-proof engagement in a borehole 15 of the latching shaft 30 of the connecting element 6. In this case, the borehole 15 is configured as a hexagon bore for a torque-proof accommodation of the hexagon nut 10. Obviously, the coupling element 7 itself may be configured as a hexagon, which reaches a torque-proof engagement with the borehole 15 of the latching shaft 30 of the connecting element 6. In the present case, the hexagon nuts 9 and 10 at the ends 12, 13, 17, and 18 of the coupling elements 7 and 8 are configured in different sizes, which facilitate orienting the coupling elements 7 and 8 during installation of the system 1. Obviously, the exterior contour of the ends 12, 13, 17, and 18 of the coupling elements 7 and 8 may also have a different contour than the one of a hexagon nut 9 and 10, such as for example the shape of a Torx or of an internal hexagon. Obviously, in this case the boreholes as well, which serve for accommodating the coupling elements 7 and 8, will have to be adapted to the shape of the ends 12, 13, 17, and 18. However, it is not necessarily required to adapt for example the borehole 15 to the exterior contour of the end 18 of the coupling element 8, to have the coupling element 8 reach a torque-proof engagement with the borehole 15. The borehole 15 could be for example likewise configured as a blind hole, into which the coupling element 8 is pressed with its end 18. Obviously, it is likewise conceivable to provide different boreholes, respectively different exterior contours of the ends 12, 13, 17, and 18 in combination with each other. Thus, the borehole 15 for example at a door actuating member 2 or 3 could be configured as a blind hole, and a borehole corresponding to the borehole 15 at the other door actuating member 3 or 2 could be configured as a hexagon bore. This embodiment could serve for a better orientation, for example during installation of the system.

In the present specific embodiment of the inventive system 1, in addition to the latching shaft 30 and the coupling element 7, the connecting element 5 comprises at the side facing the left door actuating member 2, a coupling disc 19, which with a tenon 20 engages in the latching shaft 30 of the connecting element 5.

The tenon 20 includes a corresponding recess, respectively a borehole pointing at least in a direction of the coupling element 7, by means of which recess or borehole a torque-proof engagement with the end 17 of the coupling element 7 is reached. In the Figure, the borehole is concealed and therefore not visible. Therefore in the present specific exemplary embodiment, the latching shaft 30 of the connecting element 5 is supported to be freely rotatable on the coupling element 7, and is in particular supported to be freely rotatable on the tenon 20 of the coupling disc 19, wherein the tenon 20 reaches a torque-proof engagement with the coupling element 7.

The door actuating member 2 is fittable in a torque-proof manner onto the connecting element 5, wherein the coupling disc 19, at least in portions, is accommodated in the door actuating member 2 such that, in the uncoupled condition, no torque of the door actuating member 2 is transferred onto the locking cylinder 4 via the coupling element 7. As, in the uncoupled case, the closing cam 11 does not rotate with the door actuating member 2, the lock is not unlocked and thus the door cannot be opened. It is only an authentication for example by means of a chip, a code or a card that results in coupling the door actuating member 2 to the coupling disc 19 such that the torque applied to the door actuating member 2 is transferred via the coupling disc 19, and in particular via the tenon 20 configured at the coupling disc 19, onto the coupling element 7 and thereby onto the closing cam 11.

In contrast thereto, the door actuating member 3 is supported in a torque-proof manner at the end of the latching shaft 30 of the connecting element 6 facing the door actuating member 3, such that, when actuating the door actuating member 3, the applied torque is transferred onto the locking cylinder 4 via the latching shaft 30 and the coupling element 8. As a depth abutment for the door actuating member 3, a circumferential collar 21 is configured at the end of the latching shaft 30 of the connecting element 6.

With the intention to guarantee that once the system 1 is installed, the connecting elements 5 and 6 can not be removed from the receptions 23 and 24 of the locking cylinder 4, securing elements 25 are provided at each reception 23 and 24 of the locking cylinder 4.

The securing elements 25 are retained below the receptions 23 and 24 in a non-illustrated borehole in the locking cylinder 4 at a pin-shaped portion forming the lower part of the securing elements 25 and are guided in slots 33 in the locking cylinder 4 in the area of the receptions 23 and 24. Preferably, in this case a compression spring 26 is pushed onto the pin-shaped portions of the securing elements 25, such that the securing elements 25 are spring-loaded upwards, i. e. in the direction of the receptions 23 and 24. Contrary to the illustration, in case the latching shaft of the connecting elements 5 and 6 would be able to be accommodated in receptions of the door actuating members 2 and 3, it would be conceivable to configure the securing elements 25 at the door actuating members 2 and 3. In this case, the securing elements 25 could be likewise configured as screws or as insertable pins. In the present case however, preferably spring-loaded securing elements 25 are suitable, because the locking cylinder 4 is usually installed in the lock of a door, and a manual securing by means of securing elements 25, which are configured as a screw or as an insertable pin, is not possible during installation.

The top part of the securing elements 25 is formed by means of a crescent-shaped portion. In this case, the crescent shaped portion is adapted to the size of the latching shaft 30 of the connecting element 5 and 6, in particular to the shaft troughs thereof, which are configured as annular groove 31 located on the outside. Upon inserting the latching shaft 30 of the connecting element 5 or 6, due to the spring-load, which is transferred from the compression spring 26 via the lower pin-shaped part of the securing element 25 onto the crescent-shaped portion of the securing element 25, the securing element 25 with its crescent-shaped portion thus automatically engages in an annular groove 31 of the latching shaft 30 of the connecting element 5 or 6 and, when pushing forward the latching shaft 30 of the connecting element 5 or 6 further towards the closing cam 11, slides again out of the annular groove 31 and slips beyond the ring 32 of the latching shaft 30 of the connecting element 5 or 6 which ring follows the annular groove 31. Thereupon, corresponding to the advance of the latching shaft 30 of the connecting element 5 or 6, the securing element 25 engages in the following annular groove 31. In order to comply with the requirements as to the variability of the inventive system during installation, it is therefore advantageous, if the latching shaft 30 of the connecting element 5 or 6 is equipped with as many rings 32 and annular grooves 31 in a tight succession, i. e. with a small distance to each other, in order to be able to adjust a variable distance between the door actuating members 2 and 3 and the locking cylinder 4. In case the succession of the annular grooves 31 and the rings 32, i. e. the embodiment of the latching shaft 30 of the connecting element 5 or 6 would result in the securing element 25 just not quite engaging in an annular groove 31, but bearing instead against a ring 32, in an advantageous manner it is intended to install spacers in the inventive system, such that the securing element 25 moves from the ring 32 of the latching shaft 30 of the connecting element 5 or 6 and engages into an annular groove 31 preceding the ring 32.

For securing the compression spring 26 and the securing element 25 in the borehole of the locking cylinder 4, in the lower part of the borehole, a threaded bushing 27 can be screwed to a threaded portion, wherein the threaded portion may be configured either at the lower part of the securing element 25 or in the walling of the borehole. Due to the pre-tension of the compression spring 26, which is adjustable via the threaded bushing 27, the securing element 25 with its upper part, which in the present case is configured as a crescent-shaped portion, pushes against the latching shaft 30 of the connecting element 5 or 6, whereby the securing element 25 with its upper part automatically engages in an annular groove of the latching shaft of the connecting element 5 or 6.

Instead of a multipart securing element 25, which, in the presently intended mode of operation, comprises a compression spring 26 and a threaded bushing 27, a securing element 25 with a conformed and embossed leaf spring for securing the latching shaft 30 could be retained in the reception 23 and/or 24 in a non-illustrated borehole in the locking cylinder 4 and guided in slots 33 in the locking cylinder 4 in the area of the receptions 23 and 24.

Instead of the door actuating members 2 and 3 illustrated in the Figure, which are configured as rotating knobs, wherein the door actuating member 2 is a special electronical/electromechanical rotating knob, according to the idea of the invention, the door actuating members 2 and 3 could be configured as well on both sides for example as simple rotating knobs or door handles. Obviously, likewise combinations of door handles with rotating knobs or with electronical/electromechanical rotating knobs are conceivable. Likewise one-sided fixed door knobs can be combined according to the idea of the invention with rotating knobs, electronical/electromechanical rotating knobs and door handles. It is also conceivable to install the inventive system in a knob cylinder, which, on one side, is actuated by a key and on the other side by a fixed installed rotatable knob. Altogether, the inventive system can be utilized for different construction forms, such as profile cylinders, round cylinders, oval cylinders, which are configured as half cylinders or as double cylinders.

In addition, the system should not be understood for the exclusive installation in doors. It is rather conceivable to utilize the system as well for the installation in window actuating members.

The invention in its configuration is not limited to the above presented preferred embodiment, respectively to the above indicated method. On the contrary, a number of variants are conceivable, which make use of the illustrated solution, even with basically different types of embodiments. All features and/or advantages including the constructional details, spatial dispositions and method steps, which result from the claims, the description or the drawings, may be essential to the invention, both by themselves and in their most various combinations.

1. A system comprising at least one door actuating member, a locking cylinder, and a connecting element connecting the door actuating member and the locking cylinder, which element is configured in one or more pieces and connects the door actuating member and the locking cylinder via a variable distance to each other, wherein the distance between the door actuating member and the locking cylinder can be adjusted via the connecting element.

2. The system according to claim 1, wherein the connecting element connects the door actuating member and the locking cylinder non-positively and/or positively to each other.

3. The system according to claim 1, wherein the connecting element transfers a torque from the door actuating member onto the locking cylinder.

4. The system according to claim 1, wherein the connecting element adapts an alignment of the locking cylinder in the lock between the locking cylinder and the door actuating member.

5. The system according to claim 1, wherein a release of the connection between the door actuating member and the locking cylinder is prevented up to a certain degree by means of the connecting element.

6. The system according to claim 1, wherein the door actuating member and/or the locking cylinder include(s) at least one reception for accommodating the connecting element.

7. The system according to claim 1, wherein, by latching the connecting element at or in the door actuating member and/or at or in the locking cylinder, the door actuating member and the locking cylinder are non-positively and/or positively connected to each other.

8. The system according to claim 1, wherein the connecting element can be secured at or in the door actuating member and/or at or in the locking cylinder by means of at least one securing element.

9. The system according to claim 1, wherein the connecting element comprises a latching shaft.

10. The system according to claim 8, wherein the securing element comprises a shaft securing device, which secures the connection of the latching shaft at or in the door actuating member and/or at or in the locking cylinder.

11. The system according to claim 8, wherein the securing element is spring-loaded.

12. The system according to claim 1, wherein the connecting element comprises at least one coupling element, which is configured in one or more pieces and transfers the torque of the door actuating member onto the locking cylinder.

13. The system according to claim 1, wherein at least one compensating element, by means of which an alignment error of the system can be compensated, can be disposed between the connecting element and the door actuating member.

14. A method for connecting a door actuating member to a locking cylinder, in particular while utilizing a system according to claim 1, wherein the locking cylinder and the door actuating member are non-positively and/or positively brought into engagement with each other via a connecting element.

15. The method according to claim 14, wherein the door actuating member and the locking cylinder are connected to each other via the connecting element in such a way that a torque is transferred from the door actuating member onto the locking cylinder.

16. The method according to claim 14, wherein the connecting element, for bringing the locking cylinder non-positively and/or positively into engagement with the door actuating member, is pushed into the door leaf and/or into the lock towards the locking cylinder, for connecting the connecting element to the locking cylinder, in particular for latching in a reception of the locking cylinder.

17. The method according to claim 14, wherein, after latching with the locking cylinder and/or with the door actuating member, in particular after latching in the reception of the locking cylinder, the connecting element is secured by means of a securing element.
